(19) United States
(12) Patent Application Publication
(10) Pub. No.: US 2009/0041569 A1
(43) Pub. Date: Feb. 12, 2009

(54) Robot with removable fulcra

(76) Inventor: Daniele Bellante, Segrate (Milano) (IT)

Correspondence Address: NIXON & VANDERHYE, PC, 901 NORTH GLEBE ROAD, 11TH FLOOR, ARLINGTON, VA, 22203, US

(21) Appl. No.: 11/918,630

(22) PCT Filed: Sep. 21, 2005
(86) PCT No.: PCT/EP2005/010205

§ 371 Date: Oct. 16, 2007

(30) Foreign Application Priority Data
Apr. 18, 2005 (IT) MI2005A000682

(51) Int. Cl. B25J 9/10

(52) U.S. Cl. 414/591; 901/14

(57) ABSTRACT

A robot is described for moving a certain item within a three-dimensional work area, from a picking position to a placing position. The robot comprises a first motion assembly, provided with a gripping element to pick the item and to move it within a two-dimensional work area, and a second motion assembly supporting said first motion assembly and adapted to impart thereto a lateral translation so as to define a three-dimensional work area. The first motion assembly comprises a lever system with movable fulcra operated by motorization means, through transmission means.

The present invention refers to the sector of robotics devoted to the field of packaging in the food industry and in the manufacturing industry in general, where high manipulating speeds combined with small payloads are mostly required.

Various types of manipulating systems are currently known, such as articulated or anthropomorphic robots, robots with 2, 3 or 4 axes, non interpolated Cartesian manipulators, interpolated Cartesian manipulators, SCARA robots and robots with delta-type geometry.

These manipulators present the drawback that to ensure the movement of the objects they need a variation in the mass of the lever elements which leads to a change in the performance and in the size of the motorization members.

Another complication of the manipulators of the prior art is represented by the fact that the motorization members are mounted movably in translation to follow the movement of the lever elements.

Furthermore, some manipulators, such as the interpolated Cartesian manipulators, need an opposite and simultaneous operation of the motorization members, which work in the opposite manner. This leads to a further complication of the control system of the motorization members.

The object of the present invention is to overcome the drawbacks of the prior art, providing a robot that is efficient, versatile and at the same time of low complexity, cheap and simple to produce.

This object is achieved in accordance with the invention with the characteristics listed in the appended independent claim 1.

Advantageous embodiments of the invention are apparent from the dependent claims.

The robot according to the invention serves for handling a certain item or group of items, within a three-dimensional work area, starting from a picking position and transferring the item to a placing position, thus defining trajectories composed of three movements such as a vertical, a horizontal and a lateral movement.

The robot comprises:
a first motion assembly provided with a gripping element to pick the item and to move it within a two-dimensional work area, and
a second motion assembly supporting said first motion assembly and able to impart thereto a lateral translation so as to define a three-dimensional working area in which the gripping element can be moved.

The main characteristic of the invention is represented by the fact that the first motion assembly comprises a lever system with movable fulcra operated by motorization means through transmission means.

The working geometry with movable fulcra of the first motion assembly allows the extension of the movement along a horizontal and a vertical axis, without compromising the mass of the lever elements and thus leaving the performance and the size of the motorization means unchanged.

The motorization means are advantageously mounted fixedly, do not translate with the fulcra of the lever elements and make use of the transmission means to move the lever elements, thus achieving high performance.

The lever system advantageously comprises a supporting lever that supports the gripping element and at least one reaction lever pivoted to the supporting lever. Thanks to the relationship between the supporting lever and the reaction lever it is possible to obtain a vertical movement of the end of the supporting lever which supports the gripping element, moving only one motorization element without any need for advanced movement control.

Further characteristics of the invention will be made clearer by the detailed description that follows, referring to a purely exemplifying and therefore non limiting embodiment thereof, illustrated in the appended drawings, in which:

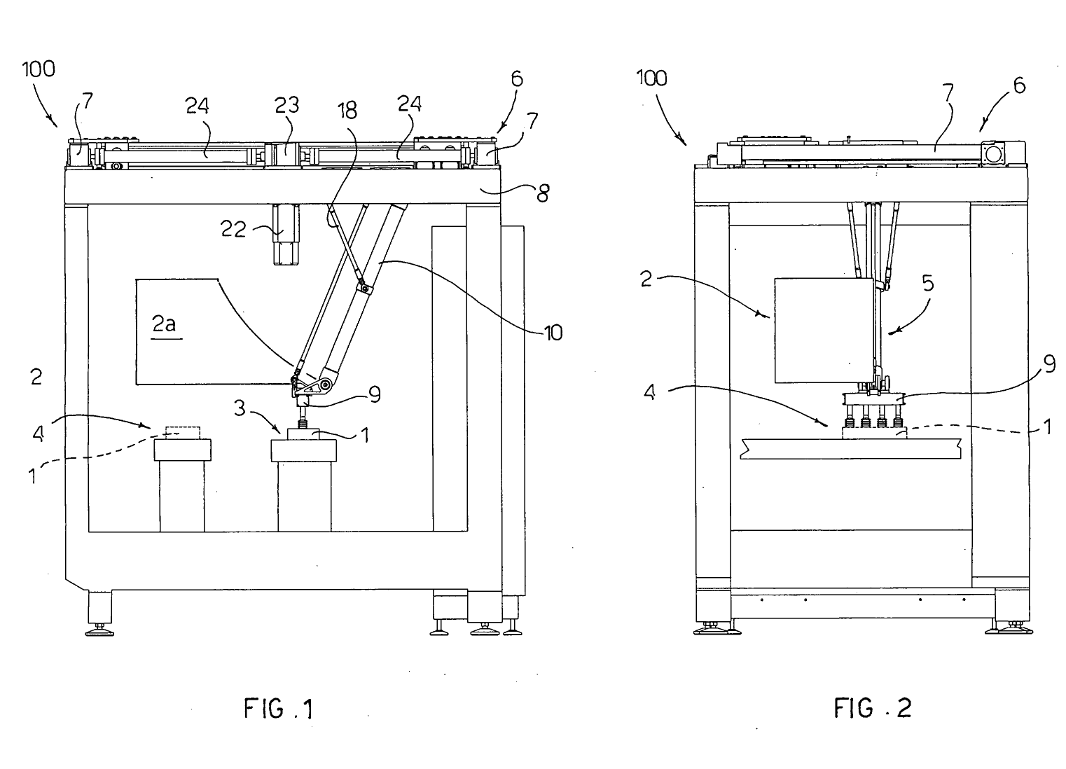

FIG. 1 is a side elevational view of the robot according to the invention;

FIG. 2 is a front view of the robot according to the invention;

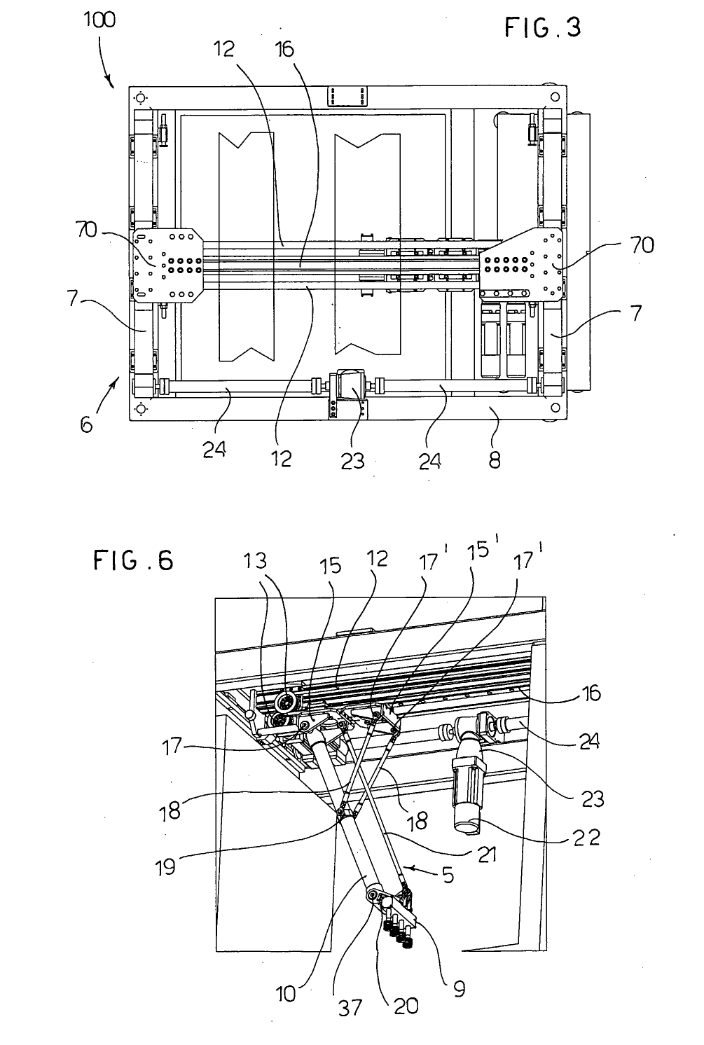

FIG. 3 is a top plan view of the robot according to the invention;

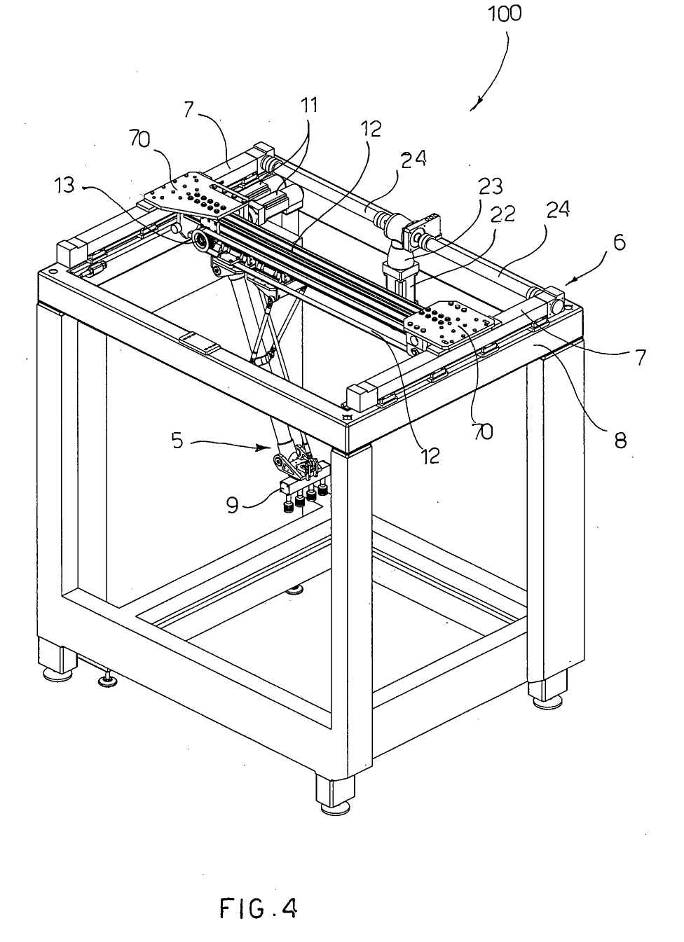

FIG. 4 is a perspective view of the robot according to the invention;

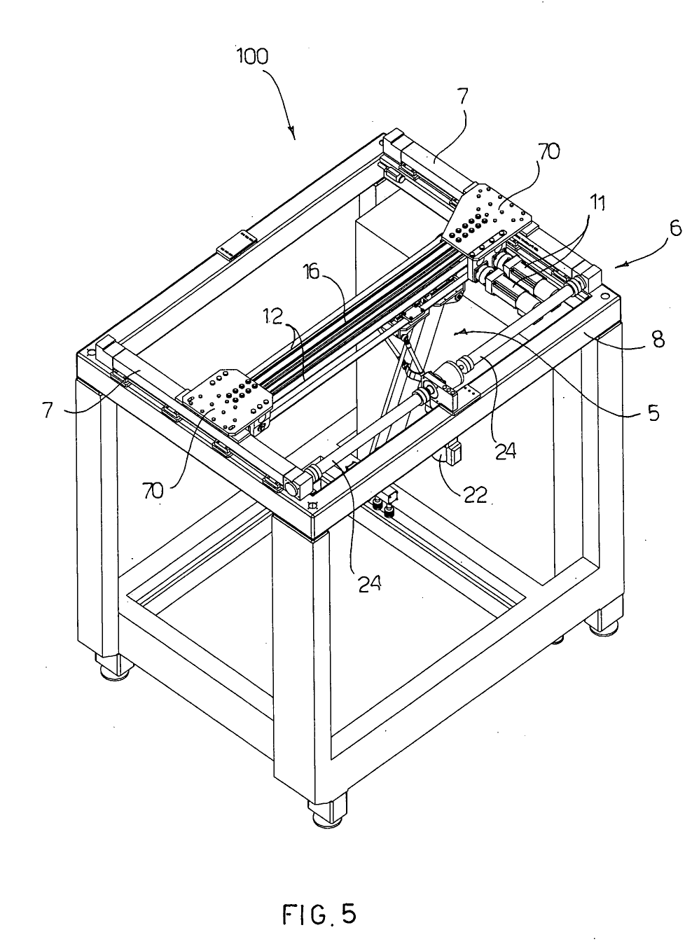

FIG. 5 is a perspective view of the robot according to the invention rotated 90° with respect to FIG. 4; and

FIG. 6 is a perspective view of a detail of the robot according to the invention illustrating the lever system in greater detail.

The robot according to the invention, denoted as a whole with reference numeral 100, is described with the aid of the figures.

With reference to FIG. 1, the robot 100 is adapted for the movement of a certain item or group of items 1, within a known three-dimensional work area 2, starting from a picking position 3 and transferring the item 1 to a placing position 4. The picking position 3 and the placing position 4 have three-dimensional coordinates defined on the completion of each handling cycle.

The robot 100 comprises a first movement assembly 5, defined as the primary motion assembly, which has a system of articulated, motorised levers. The primary motion assembly 5 is adapted to pick the item 1 and move it within a two-dimensional work area 2a (FIG. 1).

The primary motion assembly 5 is supported by a second movement assembly 6 (FIGS. 2-5) defined as the secondary motion assembly, comprising a pair of axes or of motorised linear units 7 fixed to a fixed supporting structure 8 forming part of the frame of the machine. The secondary motion assembly 6 is adapted to impart a lateral translation to the primary motion assembly 5, thus defining a three-dimensional work area 2 (FIGS. 1 and 2), in which the item 1 to be handled can be moved.

The primary motion assembly 5 is characterised by an innovative composition of three elements, which are defined motorisation means, transmission means and lever system.

The lever system comprises a supporting arm/lever 10 which supports at its bottom end a gripping apparatus or element 9, per se known, adapted to pick/release the item 1. By means of this primary motion assembly 5, it is possible to obtain a movement of the picking apparatus 9 along a vertical or horizontal trajectory, generated by only two linear horizontal movements through motorization means 11 and belt transmission means 12 (FIG. 4). The motorisation means 11 can also operate (in the simplified embodiments) without any need for advanced movement controls.

In the case in point illustrated in the appended drawings, the motorisation means comprise two pulleys 13 (FIG. 6) each driven by a servo motor 11 or, alternatively, by two three-phase motors or by pneumatic actuators. The pulleys 13 drive two respective parallel notched belts 12 to which two linear sliders 15, 15′, sliding on the same central supporting guide 16, are constrained. The sliders 15, 15′ and the guide 16 are defined as transmission elements. Furthermore, the central guide 16 supports the motors 11 and the other idle pulleys of the belts 12.

The sliders 15, 15′ support the fulcra 17, 17′ of the lever system. The lever system comprises a supporting lever/arm 10 pivoted at 17 in the first slider 15 and two parallel levers/arms 18, defined as reaction levers, pivoted at 17′ in the second slider 15′.

A bottom joint 20, generally called a “wrist”, to which the picking apparatus 9 is fixed, is pivoted at 37 in the bottom end of the supporting lever 10.

Said bottom joint 20 maintains its parallelism to the upper surface of the transmission member thanks to a tie-rod 21 which remains parallel to the supporting lever 10. The tie-rod 21 is of the same length as the supporting lever 10 and it is pivoted to the bottom joint 20 and to the first slider 15.

The supporting lever 10 has a length L, whilst the length of the reaction levers 18 is equal to ½ L. The reaction levers 18 are connected to the supporting lever 10 by means of a joint 19 situated equidistant from the two fulcra 17 and 37 of the supporting lever 10, that is to say at a distance equal to ½ L from said two fulcra 17 and 37 of the supporting lever 10. The tie-rod 21 is disposed between the two reaction levers 18 so as not to interfere therewith. Thus composed, the lever system can be defined as having movable fulcra, since the fulcra 17, 17′ of the supporting lever 10 and of the reaction levers 18 can translate linearly together with the sliders 15, 15′.

Thus, the linear movement of a single belt transmission element 12 is transferred to a single slider 15 or 15′ and to a single lever element, that is to say only to the supporting lever 10 or only to the pair of levers 18. This allows the bottom end of the supporting lever 10 to describe a vertical trajectory.

If, on the other hand, both motorization elements 11 operate simultaneously along the same directrix, a proportional horizontal translation of the sliders 15, 15′ there results which, brought back to the lever elements 10, 18, defines a proportional horizontal trajectory of the bottom end of the supporting lever 10.

If the motorization system is made with servo motors, managed by an advanced electronic movement control, it is possible to obtain composite trajectories interpolating the movements that impart the horizontal and the vertical translation of the gripping element 9 supported by the supporting lever 10.

It is thus possible to move precisely and along the most desirable trajectories a certain weight/item exerting a load on the bottom joint 20.

The elements mentioned above and defined previously as the primary motion assembly 5 are combined with a secondary motion assembly 6.

The secondary motion assembly 6 comprises two horizontal linear units 7, parallel and motorised by means of a single servo motor 22 (or three-phase motor or pneumatic actuator) supported by the fixed frame of the machine. The servo motor 22 comprises a reduction unit 23 which drives in rotation the two transmission shafts 24.

The transmission shafts 24 impart a linear translation to a pair of carriages 70 disposed on linear units 7. The carriages 70 support the central supporting guide 16 on which the sliders 15, 15′ of the lever elements slide. In this manner a movement of the primary motion assembly along a directrix at right angles to the working plane described by the lever system is obtained, allowing the machine to be able to define composite trajectories within a three-dimensional working area 2.

Numerous changes and modifications of detail within the reach of a person skilled in the art can be made to the present embodiment of the invention, without thereby departing from scope of the invention as set forth in the appended claims.

1. A robot (100) for handling a certain item or group of items (1) within a three-dimensional work area (2), starting from a picking position (3) and transferring the item (1) to a placing position (4), said robot comprising:
a first motion assembly (5) provided with a gripping element (9) for picking the item (1) and for moving it within a two-dimensional work area (2a), and
a second motion assembly (6) supporting said first motion assembly (5) and adapted to give thereto a lateral translation so as to define a three-dimensional work area (2) in which the gripping element (9) can be moved,
characterised in that
said first motion assembly (5) comprises a lever system with movable fulcra operated by motorization means (11, 13) through transmission means (12, 16, 15, 15′).

2. A robot (100) according to claim 1, characterised in that said lever system comprises fulcra (17, 17′) disposed on sliders (15, 15′) of said transmission means which perform a linear movement.

3. A robot (100) according to claim 2, characterised in that said lever system comprises:
a supporting lever (10) supporting at one end said gripping element (9) and pivoted at the other end (17) to a first slider (15), and
at least one reaction lever (18) having one end (17′) pivoted to a second slider (15′) and the other end (19) pivoted to said supporting lever (10).

4. A robot (100) according to claim 3, characterised in that said at least one reaction lever (18) has a length about half the length of said supporting lever (10) and is pivoted in an intermediate position of said supporting lever (10).

5. A robot (100) according to claim 2 or 3, characterised in that said lever system comprises a pair of reaction levers (18) disposed parallel to each other.

6. A robot (100) according to any one of claims 3 to 5, characterised in that said gripping element (9) is hinged, by means of a joint (20), to said supporting lever (10) and said joint (20) is kept in place by means of a tie-rod (21) connected to said joint (20) and to said first slider (15) so as to remain substantially parallel to said supporting lever (10).

7. A robot (100) according to any one of claims 2 to 6, characterised in that said transmission means of the first motion assembly (5) comprise belts or chains (12) that impart a linear movement to said sliders (15, 15′) which slide on a linear guide (16).

8. A robot (100) according to claim 7, characterised in that said motorization means of the first motion assembly (5) comprise two electric motors or servo motors (11) which drive in rotation the respective pulleys (13) which engage in the respective notched belts (12).

9. A robot (100) according to any one of the preceding claims, characterised in that said second motion assembly (6) comprises a pair of axes or linear units (7) supported on the frame (8) of the machine, adapted to impart a linear movement to a pair of carriages (70) supporting said first motion assembly (5).

10. A robot (100) according to claim 9, characterised in that said linear units (7) of the second motion assembly (6) are driven by means of an electric motor (22) supported on the frame of the machine which, by means of a reduction unit (23), drives in rotation two transmission shafts (24) acting on said linear units (7).
